(19) United States
(12) Patent Application Publication
(10) Pub. No.: US 2008/0272128 A1
(43) Pub. Date: Nov. 6, 2008

(54) Fuel Container For Fuel Cell

(76) Inventors: Yasuaki Norimatsu, Hitachinaka (JP); Tomoichi Kamo, Tokai (JP); Osamu Kubota, Hitachi (JP); Hideto Usui, Oyama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/586,685

(22) PCT Filed: Jan. 17, 2005
(86) PCT No.: PCT/JP05/00487

§ 371 Date: Jul. 20, 2006

(30) Foreign Application Priority Data
Jan. 20, 2004 (JP) 2004011309

(51) Int. Cl. H01M 8/04; B65D 83/60

(52) U.S. Cl. 220/500; 429/12; 222/389

(57) ABSTRACT

A fuel container for a fuel cell, comprises a liquid fuel chamber having a space for the storage of liquid fuel, a valve disposed in an outlet of the liquid fuel chamber to discharge the liquid fuel from the space or stop the discharge, a partition wall member movable through the space toward the valve, and a compressed gas chamber communicating with the space and storing compressed gas, the compressed gas imparting a back pressure to the partition wall member so that the partition wall member moves through the space toward the valve, the liquid fuel chamber and the compressed gas chamber being integral with each other. This fuel container is used as a fuel container for replenishing fuel to a fuel container installed in a fuel cell or can be installed into a fuel cell.

### TECHNICAL FIELD

The present invention relates to a fuel container for a fuel cell to be loaded to a device which incorporates a fuel cell such as a direct methanol fuel cell (DMFC) or a fuel container for a fuel cell to be used for the supply of liquid fuel such as an aqueous methanol solution to a fuel container installed in a fuel cell.

### BACKGROUND ART

As conventional containers for storing liquid there are known, for example, aerosol containers and cosmetic containers. These containers are formed using, for example, glass, metal, or a plastic material. These containers are constructed such that when the interior thereof is pressurized, a nozzle is opened and a solution present in the interior of the container flows out like a spray.

A stock solution as a chemical and a propellant for pressurizing the container interior are placed in a mixed state into each of those containers. The stock solution and the propellant are ejected in a mixed state. Therefore, when the stock solution alone is to be used, there is used a container of a double structure using a piston or the like. This technique is disclosed, for example, at page 2, right column, line 1, to page 3, left column, line 39, and FIGS. 1 and 2, of Patent Literature 1.

Patent Literature 1:

Japanese Patent Publication No. Hei 5 (1993)-20148

### DISCLOSURE OF THE INVENTION

### Problems to be Solved by the Invention

As to portable personal computers (e.g., notebook-size personal computer 100, PDA (Personal Digital Assistance)) and other electric devices, as shown in FIG. 13, the use of a fuel cell 200 is now under study as a small-sized power supply. As to the fuel cell 200, a direct methanol fuel cell (DMFC) using as fuel, for example, a mixed solution of methanol and pure water or ethanol and pure water is now under study. The fuel cell 200 requires a fuel container (e.g., fuel cartridge) 300 for the storage and supply of fuel.

The shape of fuel container 300 is determined for example in accordance with the shape of an accommodation chamber 110 of the fuel container 300 in the body of the fuel cell 200 or in such a device as the notebook-size personal computer 100 which carries the fuel cell 200 thereon. From this point, in the case of a fuel container having a cylindrical outline, not only the morphological freedom is low but also the volumetric efficiency of fuel contained is low due to a limited installation space.

Moreover, in such a fuel container as in the foregoing patent literature wherein a gas chamber for storing compressed gas for the discharge of fuel is formed in a double structure together with a liquid fuel chamber, the container assumes a large cylinder shape, causing an obstacle to the reduction in size of the device.

Further, in the case of such a small-sized device as the notebook-size personal computer 100, the entire size of the device is limited to the notebook size for example and therefore it is desired that a fuel supply pump, a pressure regulating mechanism and a fuel residue detecting mechanism be omitted. Particularly, for improving the convenience on the user side, it is desired that the fuel container 300 be inexpensive and low in both size and weight.

The present invention has been accomplished for solving the above-mentioned problems of the prior art and it is an object of the invention to provide a small-sized, light-weight and inexpensive fuel container for a fuel cell high in morphological freedom and able to eject liquid fuel with use of a simple mechanism.

### Means for Solving the Problems

According to the present invention, for solving the above-mentioned problems there is provided a fuel container for a fuel cell, comprising a liquid fuel chamber having a space for the storage of liquid fuel, a valve disposed in an outlet of the liquid fuel chamber to discharge the liquid fuel from the space or stop the discharge, a partition wall member movable through the space toward the valve, and a compressed gas chamber communicating with the space and storing compressed gas, the compressed gas imparting a back pressure to the partition wall member so that the partition wall member moves through the space toward the valve, the liquid fuel chamber and the compressed gas chamber being integral with each other.

In one concrete example of the fuel container for a fuel cell according to the present invention there is provided a fuel container for a fuel cell which not only stores liquid fuel and compressed gas but also causes the liquid fuel to be forced out by the compressed gas and supplied to the fuel cell, the fuel container comprising a container body storing the liquid fuel and the compressed gas, the container body having a connection port for supplying the liquid fuel to the fuel cell, a partition wall member disposed within the container body so as to be movable forward and backward, the partition wall member partitioning the interior of the container body into a liquid fuel chamber storing the liquid fuel and a compressed gas chamber contiguous to the liquid fuel chamber and with the compressed gas sealed therein, and a valve disposed in the connection port.

### ADVANTAGES OF THE INVENTION

In the fuel container for a fuel cell according to the present invention, the liquid fuel chamber and the compressed gas chamber are partitioned from each other by the partition wall member. Therefore, it is possible to enhance the freedom of the shape of the fuel container and thereby attain the reduction in size of the entire fuel container. Besides, the liquid fuel can be discharged to the associated fuel cell directly or to a fuel container installed in the fuel cell by the partition wall chamber which is urged with the compressed gas. Thus, it is possible to simplify the mechanism.

In the fuel container for a fuel cell according to the present invention, the shape of the fuel container can be determined easily for example in accordance with the shape of a fuel container accommodating chamber in a device. The volumetric efficiency of the liquid fuel stored therein is high and it is possible to attain the reduction in size of the fuel container. Further, the fuel container can eject fuel alone for itself and it is possible to improve the convenience on the user side by a simple mechanism and by the reduction of cost and size and weight.

### BRIEF DESCRIPTION OF THE DRAWINGS

FIG. 1 illustrates a fuel container for a fuel cell according to a first embodiment of the present invention, in which (a) is a plan view and (b) is a central sectional view;

FIG. 2 is a perspective view illustrating the fuel container for a fuel cell according to the first embodiment;

FIG. 3 illustrates the fuel container for a fuel cell according to the first embodiment, in which (a) is a side view and (b) is a front view;

FIG. 4 is a sectional view taken on line A-A in FIG. 1(b);

FIG. 5 is an enlarged sectional view illustrating a modification of the first embodiment;

FIG. 6 illustrates in what state a valve used in the fuel container for a fuel-cell according to the first embodiment is installed, in which (a) is an enlarged sectional view of a principal portion, showing a closed condition of the valve and (b) is an enlarged sectional view of a principal portion, showing an open condition of the valve;

FIG. 7 illustrates a fuel container for a fuel cell according to a second embodiment of the present invention, in which (a) is a plan view and (b) is a central sectional view;

FIG. 8 is a sectional view taken on line B-B in FIG. 7(b);

FIG. 9 is a perspective view illustrating the fuel container for a fuel cell according to the second embodiment;

FIG. 10 illustrates a fuel container for a fuel cell according to a third embodiment of the present invention, in which (a) is plan view and (b) is a central sectional view;

FIG. 11 is a sectional view taken on line C-C in FIG. 10(b);

FIG. 12 is a perspective view illustrating the fuel container for a fuel cell according to the third embodiment; and

FIG. 13 is an exploded perspective view illustrating a mounting structure of a fuel container for a fuel cell used in a conventional notebook-size personal computer.

### DESCRIPTION OF REFERENCE NUMERALS

1, 1A, 1B, 1C . . . fuel container for a fuel cell, 2, 12 . . . container body, 2b, 7a . . . connection port, 2d, 2e . . . scale indicating portion, 2f, 2g . . . scale, 4 . . . valve, 5 . . . partition wall member, 100 . . . notebook-size personal computer, 200 . . . fuel cell, F . . . liquid fuel, FR . . . liquid fuel chamber, G . . . compressed gas, GR . . . compressed gas chamber

### BEST MODE FOR CARRYING OUT THE INVENTION

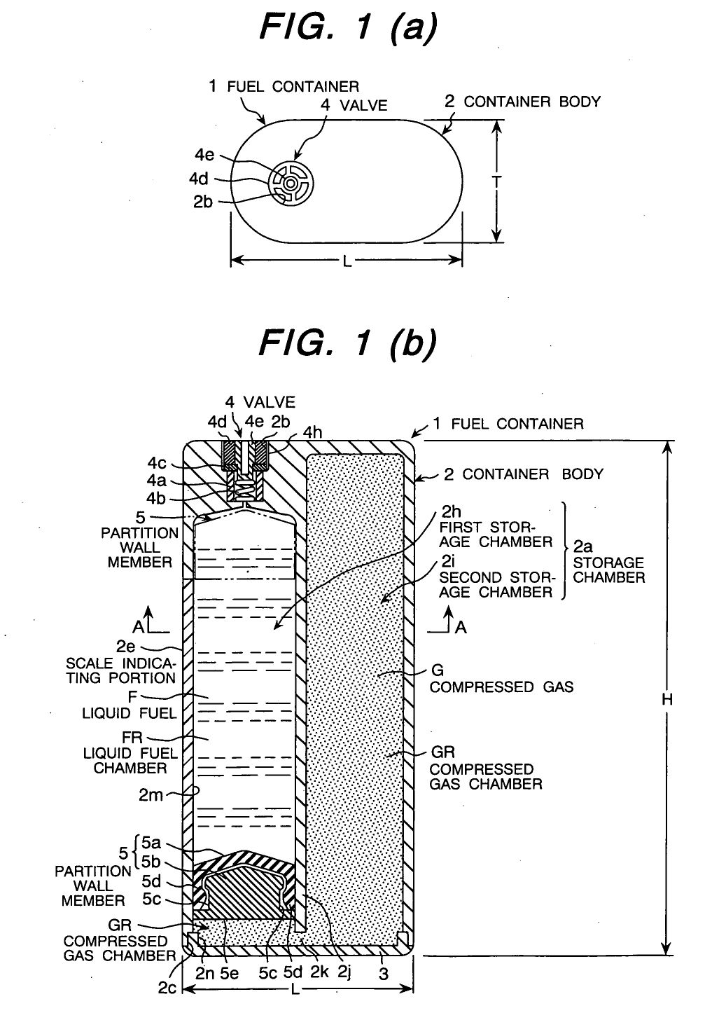

A fuel container for a fuel cell according to a first embodiment of the present invention will be described hereinunder with reference to FIGS. 1 to 6.

First, with reference to FIGS. 1 to 3 and FIG. 13, a description will be given about a fuel container for a fuel cell (hereinafter referred to simply as “fuel container”) 1.

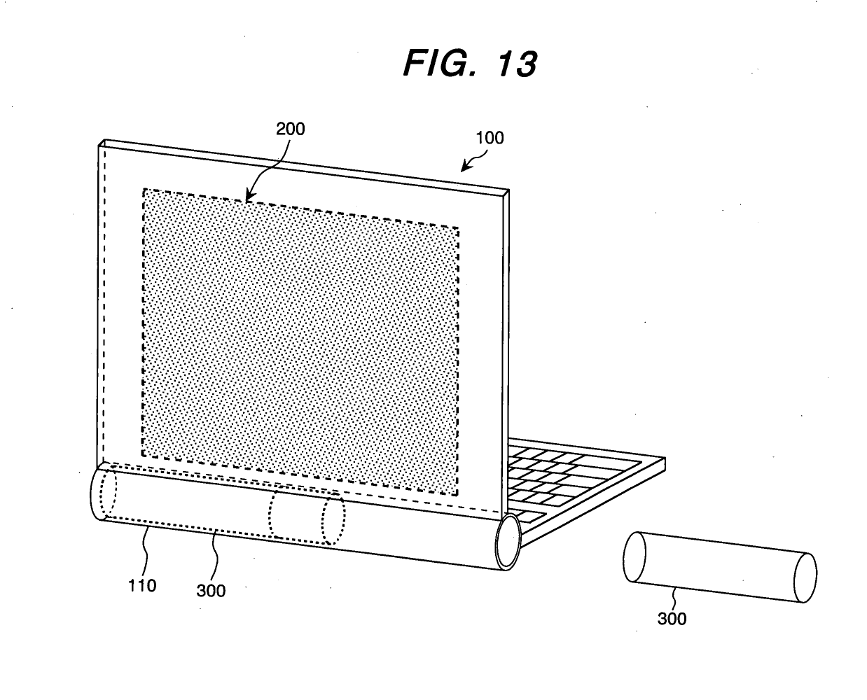

The fuel container 1 shown in FIGS. 1(a), 1(b), 2, 3(a) and 3(b) is a container for the storage of liquid fuel F to be fed to a fuel cell 200 which is mounted on such a notebook-size personal computer 100 as shown in FIG. 13 or on another device. The fuel container 1 is a replaceable cartridge type closed container loaded removably to a device incorporating a fuel cell. The fuel container 1 is connected to the fuel cell 200 such as a direct methanol fuel cell (DMFC) so as to replenish the cell with liquid fuel F.

As shown in FIG. 1(b), the fuel container 1 is constructed so as to store both liquid fuel F and compressed gas G in a storage chamber 2a formed within a container body 2 and urge the liquid fuel F with the pressure of the compressed gas G to supply the liquid fuel F to the fuel cell 200. The fuel container 1 is provided with liquid fuel F, compressed gas G, partition wall member 5, container body 2, and bottom lid member 3, has an oblong section (see FIG. 1(a)), and is formed in a flat column shape.

Next, a description will be given about the container body 2 with reference to FIGS. 1 to 4.

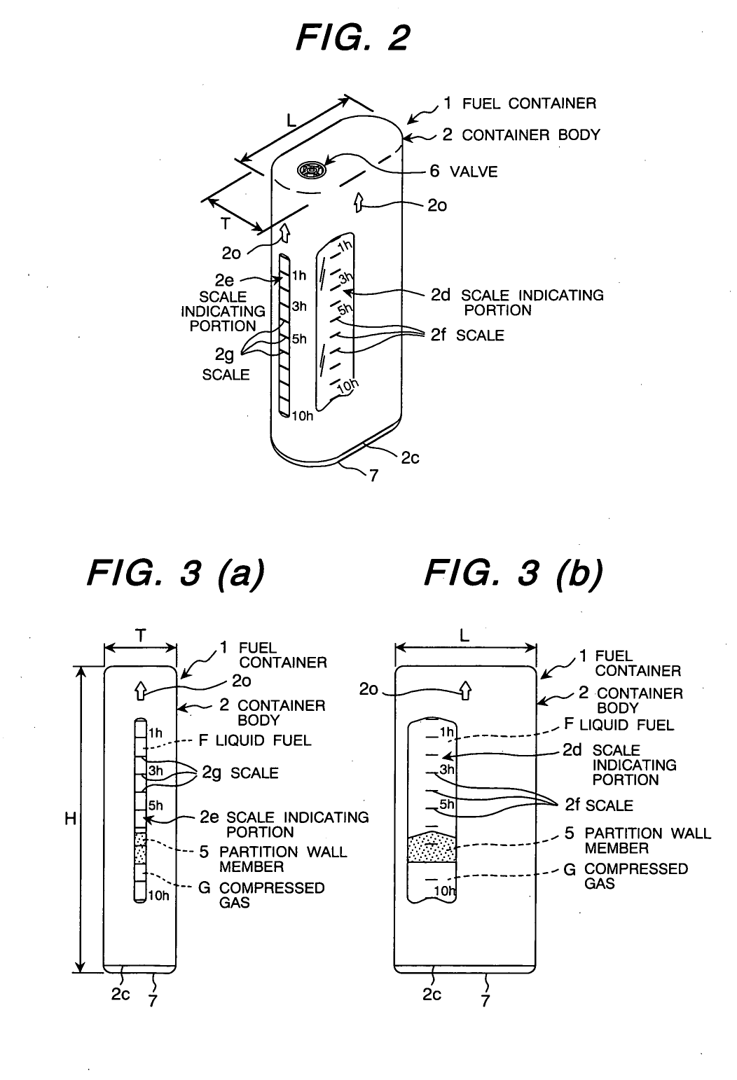

The container body 2 is formed in a thin cylindrical shape by molding a combination of a transparent material to form scale indicating portions 2d, 2e (see FIGS. 2, 3(a) and 3(b)) and an opaque synthetic resin. As shown in FIGS. 1(a) and 2, the container body 2 is formed in a flat shape having an oblong section, arcuate right and left ends, flat front and rear faces, and a small thickness T.

In the interior of the container body 2a is formed a hollow storage chamber 2a for the storage of liquid fuel F, compressed gas G and partition wall member 5. In one end portion of the storage chamber 2a is formed a connection port 2b in which is installed a valve 4 for the supply of liquid fuel F to the fuel cell 200 (see FIG. 13). In an opposite end portion of the storage chamber 2a is formed an opening 2c which is closed with a bottom lid member 3.

The storage chamber 2a is formed by a space in which the liquid fuel F, compressed gas G and partition wall member 5 are accommodated. In the storage chamber 2a, a liquid fuel chamber FR (a space for the storage of liquid fuel, as is also the case in the following) for the storage of liquid fuel F and a compressed gas chamber GR for the storage of compressed gas G are contiguous to each other. The storage chamber 2a is bisected into a first storage chamber 2h and a second storage chamber 2i by a partition wall 2j which is formed centrally in the vertical direction. The storage chamber 2a comprises the first storage chamber 2h in which the partition wall member 5 for forcing out the liquid fuel F from the connection port 2b is adapted to move reciprocatively in the aperture direction (“upward direction” hereinafter) of the connection port 2b, the second storage chamber 2i juxtaposed to the first storage chamber 2h, and a bottom-side communication path 2k which provides a communication between the first and second storage chambers 2h, 2i.

The first storage chamber 2h constitutes a cylinder within which the partition wall member 5 serving as a piston is disposed so as to slide upward and downward. With the partition wall member 5, the first storage chamber 2h is bisected into the liquid fuel chamber FR for the storage of liquid fuel F and the compressed gas chamber GR for sealing therein the compressed gas G. In the first storage chamber 2, the liquid fuel chamber FR is formed between an upper surface of the partition wall member 5 and the connection port 2b, while the compressed gas chamber GR is formed between a lower surface of the partition wall member 5 and the bottom lid member 3. The liquid fuel chamber FR and the compressed gas chamber GR are formed so that their volumes vary with movement of the partition wall member 5. With the compressed gas in the compressed gas chamber, a back pressure is imparted to the partition wall member, causing the partition wall member to move toward the valve.

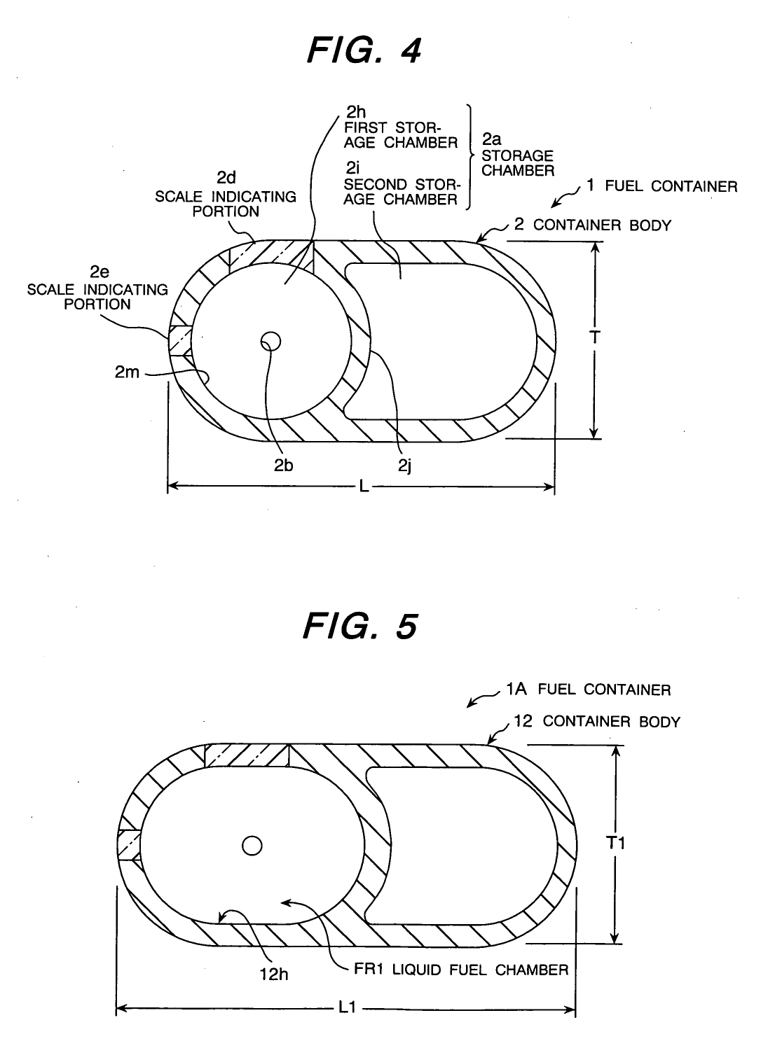

As shown in FIG. 4, an inner wall 2m of the first storage chamber (liquid fuel chamber FR) 2h is formed in a cylindrical shape so that the partition wall member 5 formed in a generally columnar shape is fitted therein vertically movably. Part of the inner wall 2m of the first storage chamber (liquid fuel chamber FR) 2h is formed by a partition wall 2j of an arcuate section and scale indicating portions 2d and 2e. The scale indicating portions 2d and 2e are formed of a light transmitting material so that the liquid fuel F in the liquid fuel chamber FR and the partition wall member 5 are visible from the outside. The scale indicating portions 2d and 2e are formed on the container body 2 in which is formed the first storage chamber (liquid fuel chamber FR). The scale indicating portions 2e and 2e have scales (residual quantity time) 2f and 2g which indicate the position of the partition wall member 5, thereby permitting a visual check of the amount of liquid fuel F.

The section of the first storage chamber (liquid fuel chamber FR) 2h is not limited to a circular section. As in a fuel container 1A shown in FIG. 5, the first storage chamber (liquid fuel chamber FR) may be formed in a cylindrical shape of an oblong section. Further, the thickness T1 may be made small and the container body 12 may be formed flat by molding.

In comparison with the fuel container 1, the fuel container 1A can be made thinner in its thickness direction and hence can be loaded easily into such a portable device as a thin notebook-size personal computer 100 (see FIG. 13).

Besides, since the fuel container 1A is of an oblong section, the partition wall member 5 does not rotate in the circumferential direction.

The whole of the second storage chamber 2i forms the compressed gas chamber GR with compressed gas G sealed therein and is adjacent and juxtaposed to the first storage chamber 2h in the width direction. Therefore, as to the storage chamber 2a for storage of both liquid fuel F and compressed gas G, by shortening the vertical height of the first storage chamber (liquid fuel chamber FR) with liquid fuel F stored therein and that of the second storage chamber (compressed gas chamber GR) with compressed gas G stored therein, it becomes possible to shorten the overall height H of the fuel container 1 and construct the fuel container in a compact shape.

Between the first and second storage chambers 2h, 2i is formed a communication path 2k by cutting out a lower end portion of the partition wall 2i. The communication path 2k is formed so that the bottom of the first storage chamber 2h and that of the second storage chamber 2i are put in communication with each other when the bottom lid member 3 is fitted in the opening 2c of the container body 2 to form the fuel container 1.

The liquid fuel chamber FR, in which liquid fuel F is stored, is a space formed between the partition wall member 5 in the first storage chamber 2h and the connection port 2b.

The compressed gas chamber GR, in which compressed gas G is stored, comprises a space formed between the partition wall member 5 in the first storage chamber 2h and the bottom lid member 3, the communication path 2k, and the second storage chamber 2i.

The volume of the liquid fuel chamber FR and that of the compressed gas chamber GR vary as the partition wall member 5 which provides a partition between the two chambers moves on the basis of the amount of the liquid fuel F.

In order for the fuel container 1 to be able to cope with the case where a residual quantity monitor window is positioned on a side or front face in a certain device with the fuel container loaded therein, the scale indicating portions 2d and 2e are formed in an elongated shape on both front and side faces of the container body 2. The scale indicating portions 2d and 2e are formed using a light transmitting resin such as, for example, acrylic resin.

The scales 2f and 2g are formed on outer surfaces of the scale indicating portions 2d and 2e for example by transfer printing or by winding paper or film around the outer surfaces. On the outer surface of the container body 2 are further formed indications such as design, commodity name and advertisement, as well as an arrow indication 20 indicating a loading direction of the fuel container 1.

As shown in FIG. 1(b), the bottom lid member 3 is a generally plate-like resin member of an oblong section and having an annular protuberance 2n fitted in the opening 2c. The bottom lid member 3 is fixed to the opening 2c by ultrasonic welding for example. The bottom lid member 3 constitutes the bottom of the compressed gas chamber GR (first and second storage chambers 2h, 2i). The annular protuberance 2n is formed so as to protrude into the first storage chamber located inside the opening 2c which is formed in a stepped shape. The protruded portion functions as a stopper against the partition wall member 5. With the annular protuberance 2n, the partition wall member 5 is kept out of close contact with the bottom of the bottom lid member 3.

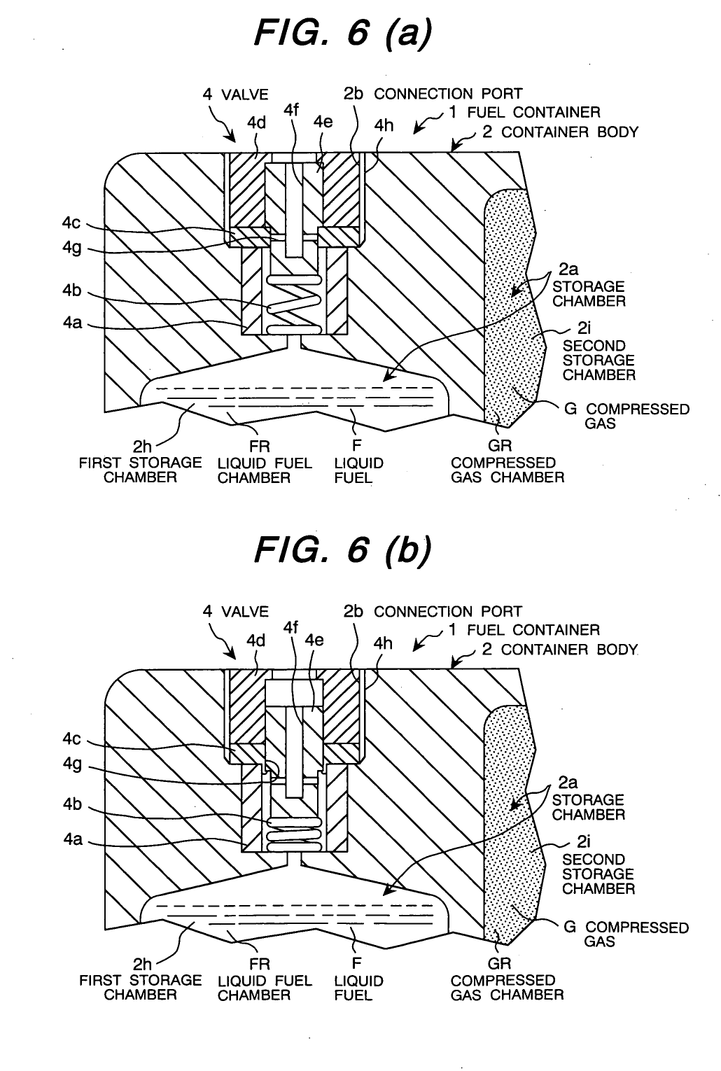

Next, a description will be given below about the valve 4 with reference to FIGS. 6(a) and 6(b).

As shown in FIGS. 6(a) and 6(b), the valve 4 is fitted in the connection port 2b which is formed in a stepped shape. The valve 4 is an on-off valve adapted to open and close to permit and shut off the flow of liquid fuel F. The valve 4 is formed above the first storage chamber (liquid fuel chamber FR) 2h in the container body 2.

The valve 4 comprises a spacer 4a, a helical compression spring 4b, a gasket 4c, a generally cylindrical valve stem 4d having a hollow portion 4f and a communication hole 4g, and a fixing member 4e.

The spacer 4a is formed by a cylindrical member disposed on a peripheral wall portion of the bottom in the connection port 2b. The spacer 4a supports the helical compression spring 4b, which is loosely fitted in the spacer 4a.

The helical compression spring 4b, which is for urging the fixing member 4e, is disposed on the bottom in the connection port 2b.

The gasket 4c is formed by a synthetic rubber ring for example and is placed on the spacer 4a.

The valve step 4d is inserted into the gasket 4c and is placed on the helical compression spring 4b.

The fixing member 4e has a screw portion 4h formed on its peripheral surface, the screw portion 4h being threadedly engaged with an internally threaded portion (not shown) formed on an inner wall of the connection port 2b. Further, the fixing member 4e urges the valve stem 4d toward the bottom (liquid fuel chamber FR) of the connection port 2b against the elastic force of the helical compression spring 4b.

Next, a description will be given below about the partition wall member 5 with reference to FIG. 1(b).

As shown in FIG. 1(b), the partition wall member 5 is inserted slidably into the first storage chamber 2h serving as a cylinder and serves as a piston for urging the liquid fuel F. Further, the partition wall member 5 partitions the first storage chamber 2h into the liquid fuel chamber FR and the compressed gas chamber GR. The partition wall member 5 comprises a sealing member 5a having elasticity and a core member 5b having a bottom 5e which undergoes the compressive force of the compressed gas G. The partition wall member 5 is formed in a generally columnar shape having the same circular section as that of the inner wall 2m shown in FIG. 4.

The sealing member 5a is formed so as to cover the core member 5 and is provided at a lower end portion thereof with a retaining pawl 5d, which is engaged in a recess 5c of the core member 5b. Thus, the sealing member 5a is made integral with the core member 5b. The outer periphery of the sealing member 5a is in airtight contact with the inner wall 2m of the first storage chamber 2h. Liquid fuel F is sealed into the space, which overlies the partition wall member 5, while compressed gas G is sealed into the space which underlies the partition wall member 5.

With this construction, the partition wall member 5 operates in the following manner. When the partition wall member 5 slides through the interior of the container body 2 while retaining a predetermined attitude thereof and while being guided by the inner wall 2m of the first storage chamber 2h, the liquid fuel F is urged by the pressure of the compressed gas G and is forced out from the connection port 2b as the valve 4 operates into communication with the first storage chamber 2h.

Next, a description will be given below about the liquid fuel F with reference to FIG. 1(b).

The liquid fuel F shown in FIG. 1(b) is, for example, a mixture comprising mainly methanol and water. In this embodiment, since the fuel container 1 is loaded into a portable device which incorporates a DMFC, the liquid fuel F is a mixed solution of methanol and pure water or ethanol and pure water with a predetermined concentration. However, the type of liquid fuel is not limited thereto, but may be changed as necessary according to the type of the fuel cell concerned.

Next, a description will be given below about the compressed gas G with reference to FIG. 1(b). As the compressed gas G shown in FIG. 1(b) it is preferable to use an oxygen-free gas such as, for example, nitrogen, carbon dioxide, or deoxidated air. With such an oxygen-free gas, oxygen which exerts a bad influence on the reaction in the fuel cell can be prevented from being mixed into the liquid fuel F and it is also possible to prevent oxidation of the liquid fuel F.

The pressure of the compressed gas G is not specially limited if only the liquid fuel F injected into the liquid fuel chamber FR can be forced out completely even in a state in which the amount thereof is small. In the case where the portable device concerned is provided with neither a fuel supply pump nor a pressure regulating mechanism, it is preferable to set the maximum pressure of the compressed gas G at 0.3 MPaG or lower. In this case, the pressure of the compressed gas G is set so as to be 0.3 MPaG in a state in which the amount of the liquid fuel F injected is maximum (the volume of the liquid fuel chamber FR is maximum and that of the compressed gas chamber GR is minimum).

For minimizing a pressure variation of the compressed gas G it is preferable that the volume of the compressed gas chamber GR be as large as possible.

Next, the following description is provided about the fuel container for a fuel cell according to this first embodiment.

First, as shown in FIG. 1(b), the compressed gas G is sealed into the compressed gas chamber GR. For example, this is done in the following manner. In an empty state of the liquid fuel chamber FR not filled with the liquid fuel F, the compressed gas G is injected into the liquid fuel chamber FR from the connection port 2b through the valve 4. The injection of the compressed gas is continued until the partition wall member 5 moves to the lowest portion of the liquid fuel chamber FR. At this time, an end portion of the bottom 5e of the partition wall member 5 tilts in abutment against the annular protuberance 2n. As a result, the hermetically sealed condition between the partition wall member 5 and the inner wall 2m is released and the liquid fuel chamber FR and the compressed gas chamber GR are brought into communication with each other, whereby the compressed gas G is injected into the compressed gas chamber GR. The injection of the compressed gas G is stopped when the internal pressure of the compressed gas chamber GR reaches a predetermined pressure. Thereafter, the valve 4 is operated in its opening direction to discharge the compressed gas G present in the interior of the liquid fuel chamber FR, resulting in that with the pressure of the compressed gas G the partition wall member 5 moves and the liquid fuel chamber FR reverts to its original hermetically closed state.

Since the pressure of the compressed gas G acts on the bottom 5e of the partition wall member 5, the partition wall member rises up to the upper end of the liquid fuel chamber FR, whereby the compressed gas G in the compressed gas chamber GR can be sealed into the storage chamber so that all of the liquid fuel F can be discharged. Thereafter, the valve 4 in the connection port 2b is opened and the liquid fuel F is injected into the liquid fuel chamber FR, whereby the fuel container 1 can replenish the portable device with the liquid fuel F.

In the case where the fuel container 1 is not loaded into a portable device such as the notebook-size personal computer 100 (see FIG. 13), the communication hole 4g of the valve stem 4d is shut off by the gasket 4c and the valve 4 is closed, as shown in FIG. 6(a). Therefore, the liquid fuel F in the liquid fuel chamber FR of the fuel container 1 is in an injected state without leakage from the valve 4. Since the bottom 5e of the partition wall member 5 is urged by the pressure of the compressed gas G, the liquid fuel F is in a compressed state by the upper surface of the partition wall member 5.

When the fuel container 1 is loaded into the portable device, as shown in FIG. 4(b), the valve stem 4d is forced down, so that the gasket 4c undergoes a compressive deformation and the communication hole 4g is opened (open condition). As a result, the liquid fuel F which is in a compressed state within the liquid fuel chamber FR is forced out from the liquid fuel chamber FR with the compressive force of the compressed gas G, then passes through the communication hole 4g and the hollow portion 4f, then is ejected to the exterior of the fuel container 1 and is supplied to the fuel cell 200 (see FIG. 13) installed in the portable device.

As the liquid fuel F is supplied to the fuel cell 200 (see FIG. 13) and the amount of fuel present within the fuel container 1 decreases, the position of the partition wall member 5 varies depending on the amount (residual quantity time, h) of the liquid fuel F remaining in the fuel container. The movement of the partition wall member 5 can be visually checked by the scale indicating portions 2d and 2e and the amount (residual quantity time, h) of the liquid fuel F stored can be measured by the scales 2f and 2g. Although the volume of the compressed gas G varies and the pressure thereof somewhat decreases in accordance with the decrease in the amount of the liquid fuel F, the partition wall member 5 is urged with the pressure of the compressed gas G falling under a predetermined pressure range and moves. Thus, the liquid fuel F can be forced out until the amount of the liquid fuel stored becomes zero. That is, as shown in phantom in FIG. 1(b), when the partition wall member 5 moves up to the upper end of the liquid fuel chamber FR, it comes to a stop in abutment against the upper end face of the liquid fuel chamber FR. Thus, all of the liquid fuel F stored in the liquid fuel chamber FR can be forced out.

Since the partition wall member 5 is constructed so as to stop at the upper end of the liquid fuel chamber FR, nothing is ejected to the exterior of the fuel container 1 except the liquid fuel F. Besides, since the interior of the container body 2 is divided into the liquid fuel chamber FR and the compressed gas chamber GR, it is possible to prevent the occurrence of fuel leakage caused by a shock such as falling.

Moreover, in the fuel container 1, since the first and second storage chambers 2h, 2i are laterally juxtaposed to each other, it is possible to form the fuel container in a flat shape, as shown in FIGS. 1 to 4. Consequently, it becomes possible to apply the fuel container 1 to even a notebook-size personal computer 100 (see FIG. 13) or PDA for which a high space efficiency is required. Thus, it is possible to constitute a small-sized fuel container 1 having a large storage volume.

### SECOND EMBODIMENT

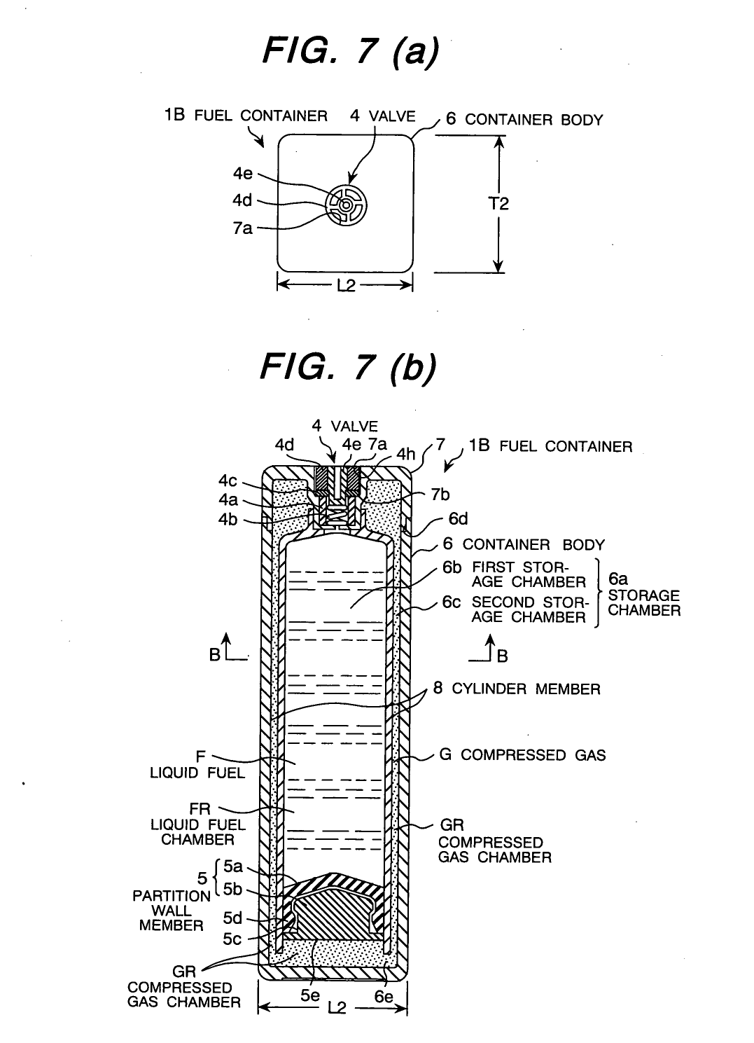

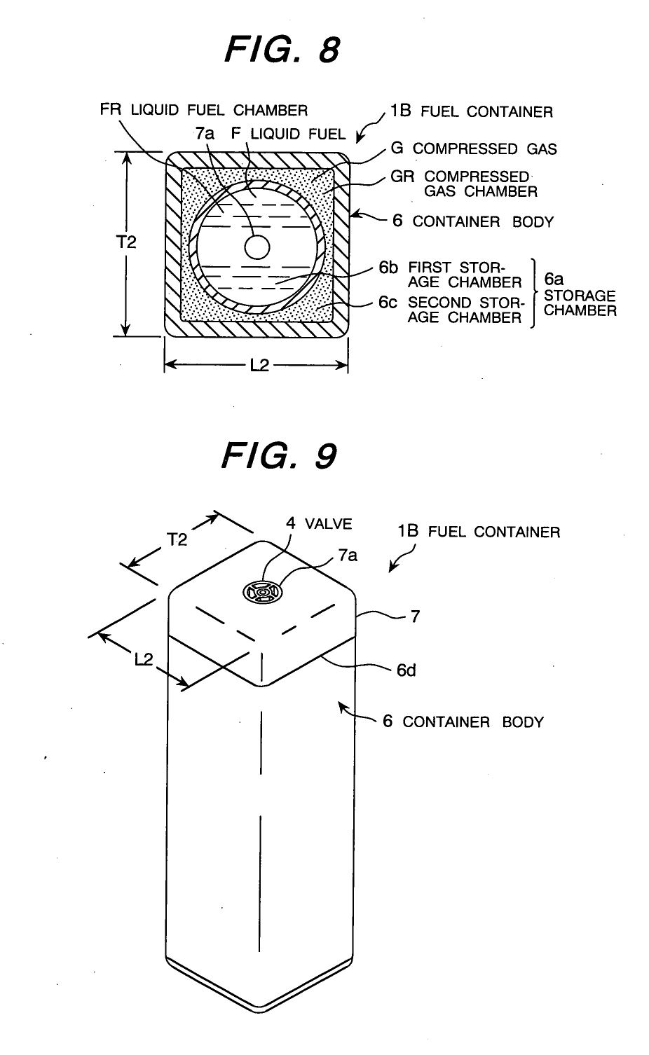

Next, with reference to FIGS. 7 to 9, a description will be given below about a fuel container for a fuel cell according to a second embodiment of the present invention.

The same portions as in the first embodiment are identified by the same reference numerals as in the first embodiment and explanations thereof will be omitted.

In this second embodiment, a storage chamber 6a of a fuel container 1B is divided into a first storage chamber (liquid fuel chamber FR) 6b located inside and a second storage chamber (compressed gas chamber GR) 6c located outside the first storage chamber 6b. Thus, the first and second storage chambers 6b, 6c are disposed double. Thickness T2 and width L2 are set short in equal length to afford a compact outline.

The fuel container 1B comprises a container body 6 having an upper opening 6d, an upper lid member 7 fitted in the opening 6d of the container body 6, a valve 4 installed in a connection port 7a which is formed centrally of an upper surface of the upper lid member 7, and a generally cylindrical member 8 installed under the valve 4 which is mounted in the upper lid member 7. As shown in FIG. 9, since the compressed gas chamber GR is adjacent to the liquid fuel chamber FR, the fuel container 1B can be formed in the shape of a quadrangular prism. Consequently, the width L2 can be made shorter than the width L of the fuel container 1 (see FIG. 2) of the first embodiment.

In the fuel container 1B, since the fuel container 1B is disposed around the first storage chamber 6b, the morphological freedom increases and the outline sectional shape can be made quadrangular, circular, or oblong. For example, the fuel container 1B may be formed in a columnar shape by forming the container body 6 and the upper lid member 7 in a cylindrical shape.

For example, the container body 6 is formed by a bottomed cylinder having a quadrangular section and the cylinder member 8 is disposed inside through a predetermined spacing. According to this arrangement, the second storage chamber 6c is formed between the inner wall of the container body 6 and the cylinder member 8.

The upper lid member 7 is fitted in the opening 6d of the container body 6 and is kept in close contact with the opening by ultrasonic welding for example.

An upper end portion of the cylinder member 8 is fitted on a valve mounting portion 7b of the upper lid member 7, while a lower end portion thereof is floated from an inner bottom of the container body 6 to form a communication path 6e. Liquid fuel F and a partition wall member 5 serving as a piston are accommodated in the interior of the cylinder member 8. The interior of the cylinder member 8 forms the first storage chamber 6b. With the partition wall member 5, the first storage chamber 6b is partitioned into the liquid fuel chamber FR for storage of the liquid fuel F and the compressed gas chamber GR which is in communication with the second storage chamber 6c.

Since the fuel container for a fuel cell according to this second embodiment is thus constructed, it is possible to provide a fuel container 1B of a short width L2 and applicable easily to such a portable device as the thin notebook type personal computer 100 (see FIG. 13).

It goes without saying that the present invention is not limited to the above first and second embodiments, but that various modifications and changes may be made within the scope of its technical idea and that the present invention covers such modified and changed invention.

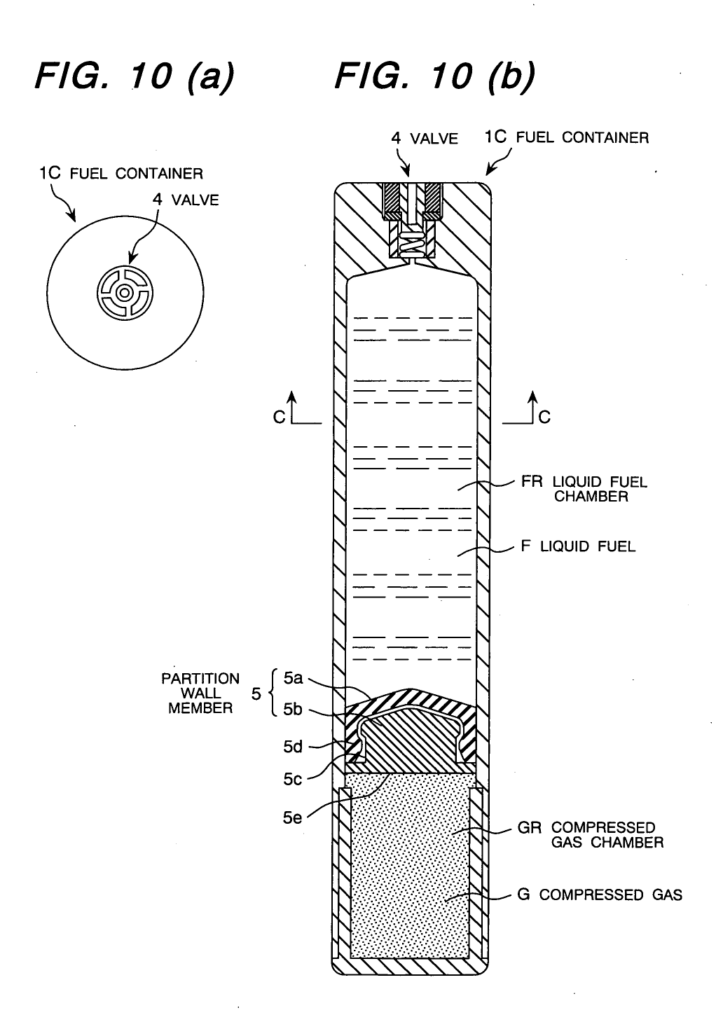

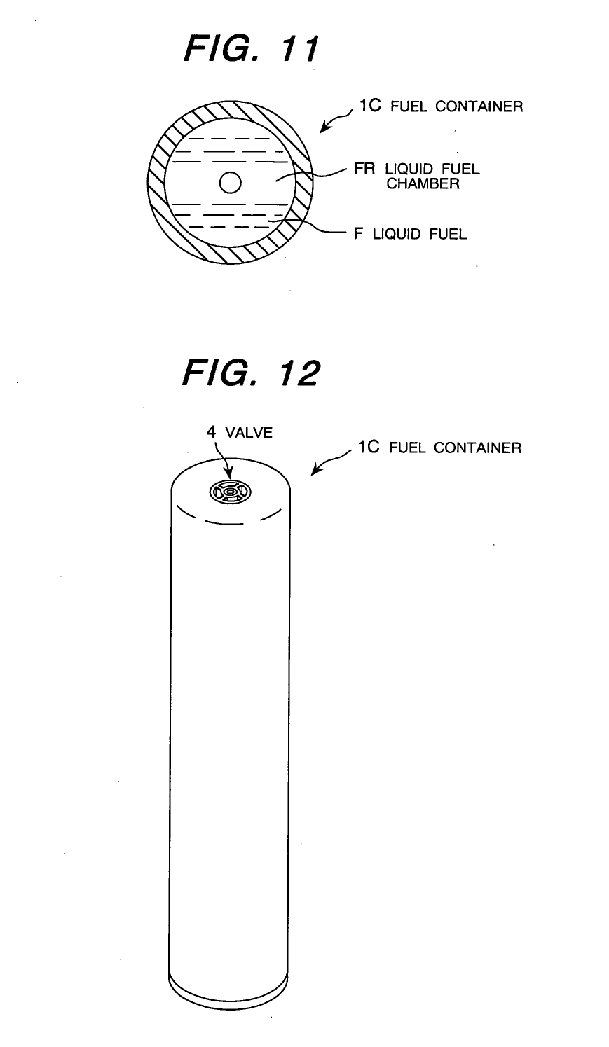

Although in each of the fuel containers 1 and 1B related to the above first and second embodiments the liquid fuel chamber FR and the compressed gas chamber GR are arranged side by side in the width direction or in the outer periphery direction, the arrangement of both chambers FR and GR is not limited thereto. For example, the fuel container may be such an elongated fuel container 1C as shown in FIGS. 10 to 12 wherein both liquid fuel chamber FR and compressed gas chamber GR are arranged in series (linearly) in the vertical direction.

Thus, since the liquid fuel chamber FR and the compressed gas chamber GR in the fuel container 1C are arranged in a straight line, it is possible to thin the whole of the fuel container 1C and attain a compact construction thereof.

Although the fuel container 1 is to be loaded to a fuel cell for the supply of fuel directly to the fuel cell, it is also employable as a fuel-injecting fuel container to be increased its internal pressure for injecting the liquid fuel F into a fuel container for a fuel cell capable of being re-loaded with fuel.

### INDUSTRIAL APPLICABILITY

The present invention can be utilized as a fuel container for a liquid fuel cell or as a fuel container for the supply of fuel to a fuel container installed in a fuel cell.

1. A fuel container for a fuel cell, comprising:
a liquid fuel chamber having a space for the storage of liquid fuel;
a valve disposed in an outlet of the liquid fuel chamber to discharge the liquid fuel from the space or stop the discharge;
a partition wall member movable through the space toward the valve; and
a compressed gas chamber communicating with the space and storing compressed gas, the compressed gas imparting a back pressure to the partition wall member so that the partition wall member moves through the space toward the valve,
the liquid fuel chamber and the compressed gas chamber being integral with each other.

2. A fuel container for a fuel cell according to claim 1, wherein the valve is constructed so as to be connectable to a fuel supply port of the fuel cell.

3. A fuel container for a fuel cell which not only stores liquid fuel and compressed gas but also causes the liquid fuel to be forced out by the compressed gas and supplied to the fuel cell, the fuel container comprising:
a container body storing the liquid fuel and the compressed gas, the container body having a connection port for supplying the liquid fuel to the fuel cell;
a partition wall member disposed within the container body, the partition wall member partitioning the interior of the container body into a liquid fuel chamber storing the liquid fuel and a compressed gas chamber contiguous to the liquid fuel chamber and with the compressed gas sealed therein; and
a valve disposed in the connection port.

4. A fuel container for a fuel cell according to claim 1, wherein the fuel container is constructed so that it can be loaded into a device incorporating a fuel cell.

5. A fuel container for a fuel cell according to any of claims 1 to 3, wherein the container body is formed in the shape of a cylinder, the liquid fuel chamber is formed in the shape of a cylinder or in a tubular shape having an oblong section.

6. A fuel container for a fuel cell according to any of claims 1 to 3, wherein the compressed gas chamber in the container body is adjacent and juxtaposed to the liquid fuel chamber.

7. A fuel container for a fuel cell according to any of claims 1 to 3, wherein the compressed gas chamber in the container body is adjacent to the liquid fuel chamber.

8. A fuel container for a fuel cell according to any of claims 1 to 3, wherein the maximum pressure of the compressed gas is 0.3 MPaG or lower.

9. A fuel container for a fuel cell according to any of claims 1 to 3, wherein the compressed gas is an oxygen-free gas.

10. A fuel container for a fuel cell according to any of claims 1 to 3, wherein at least a part of the liquid fuel chamber is formed of a light transmitting material.

11. A fuel container for a fuel cell according to any of claims 1 to 3, wherein the container body has scales indicating the position of the partition wall member.

12. A fuel container for a fuel cell according to any of claims to 3, wherein the liquid fuel is a mixture of methanol and water.
